(19) United States
(12) Patent Application Publication
(10) Pub. No.: US 2026/0339451 A1
(43) Pub. Date: Oct. 29, 2026

(54) TERMINAL, OPERATION METHOD, AND PROGRAM

(71) Applicant: KYOCERA Corporation, Kyoto-shi, Kyoto (JP)

(72) Inventor: Naoki MATSUO, Yokohama-shi, Kanagawa (JP)

(21) Appl. No.: 19/115,251

(22) PCT Filed: May 13, 2024
(86) PCT No.: PCT/JP2024/017689

§ 371 Date: Mar. 26, 2025

(30) Foreign Application Priority Data
May 23, 2023 (JP) 2023-084861

(51) Int. Cl. G06F 3/041; G06F 3/044

(52) U.S. Cl. CPC G06F 3/0416; G06F 3/0446; G06F 2203/04101; G06F 2203/04112

(57) ABSTRACT

A terminal includes a display and a controller. The controller is configured to determine a user designation for an object displayed on the display based on information on a first operator and information on a second operator, the first operator and the second operator hovering relative to the display.

### CROSS-REFERENCE TO RELATED APPLICATIONS

The present application claims priority to Japanese Patent Application No. 2023-084861, filed on May 23, 2023, which is hereby incorporated by reference herein in its entirety.

### TECHNICAL FIELD

The present disclosure relates to a terminal, an operation method, and a program.

### BACKGROUND OF INVENTION

Technologies for detecting non-contact operations have been known. For example, Patent Literature 1 describes that the direction of movement of an operator is determined and a process associated with the determined direction of movement is executed.

### CITATION LIST

### Patent Literature

Patent Literature 1: Japanese Unexamined Patent Application Publication No. 2019-212087

### SUMMARY

In an embodiment of the present disclosure, a terminal includes a display and a controller. The controller is configured to determine a user designation for an object displayed on the display based on information on a first operator and information on a second operator, the first operator and the second operator hovering relative to the display.

In an embodiment of the present disclosure, an operation method includes determining a user designation for an object displayed on a display based on information on a first operator and information on a second operator, the first operator and the second operator hovering relative to the display.

In an embodiment of the present disclosure, a program causes a computer to execute an operation including determining a user designation for an object displayed on a display based on information on a first operator and information on a second operator, the first operator and the second operator hovering relative to the display.

### BRIEF DESCRIPTION OF THE DRAWINGS

FIG. 1 is an external view of a terminal in accordance with an embodiment of the present disclosure.

FIG. 2 is a top view of a display unit illustrated in FIG. 1.

FIG. 3 is a block diagram of the terminal illustrated in FIG. 1.

FIG. 4 is a flowchart illustrating an example determination process in accordance with an embodiment of the present disclosure.

FIG. 5 is a flowchart illustrating an example determination process in accordance with an embodiment of the present disclosure.

FIG. 6 is a diagram illustrating an XY coordinate system set on a display.

FIG. 7 is a diagram illustrating the XY coordinate system set on the display.

FIG. 8 is a diagram illustrating the XY coordinate system set on the display.

FIG. 9 is a diagram illustrating an example display manner on the display.

FIG. 10 is a diagram illustrating an example display manner on the display.

FIG. 11 is a block diagram of a terminal in accordance with another embodiment of the present disclosure.

FIG. 12 is a diagram illustrating the display oriented substantially parallel to the vertical direction.

FIG. 13 is a diagram illustrating the display oriented substantially parallel to the horizontal direction.

FIG. 14 is a flowchart illustrating an example notification process in accordance with another embodiment of the present disclosure.

### DESCRIPTION OF EMBODIMENTS

An improved accuracy of detecting a non-contact operation leads to usefulness. In an embodiment of the present disclosure, the accuracy of detecting a non-contact operation can be improved.

An embodiment of the present disclosure will be described below with reference to the drawings.

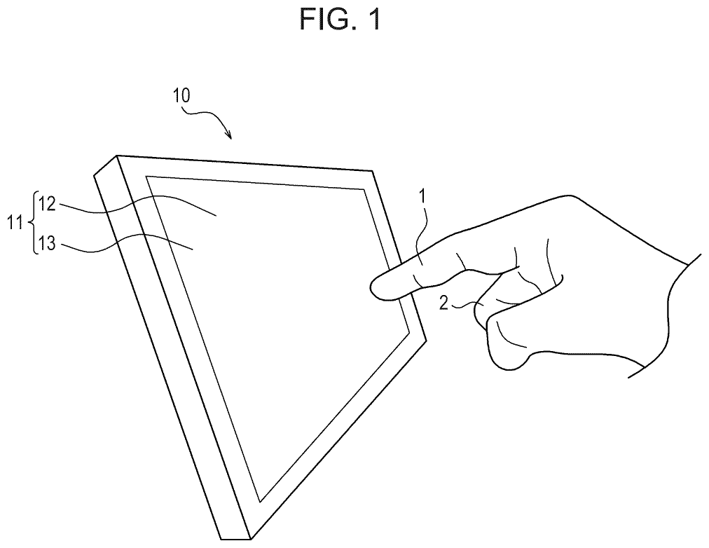

In the embodiment, as illustrated in FIG. 1, a terminal 10 includes a display unit 11. The display unit 11 displays various objects to be operated by a user. Examples of the objects include an icon, a window, a toolbar, a menu, a button, and a slider. The terminal 10 detects a non-contact operation by a user for an object.

The terminal 10 may be used in any place. By way of example, the terminal 10 may be used in a place where user's hands get dirty or wet. In this case, the terminal 10 may be used in, for example, a kitchen, a bathroom, or a factory.

In the embodiment, a user operation for determining a designation for an object displayed on the display unit 11 will be described below.

First, the user directs a first operator 1 in a hovering state toward an object that the user intends to operate among objects displayed on the display unit 11. The user keeps the first operator 1, which is directed toward the object, in the hovering state stationary. The hovering state, or hovering, refers to a state in which the operator is located within a predetermined distance from the display unit 11 and is not in contact with the display unit 11. The predetermined distance is, for example, a distance corresponding to a capacitance threshold, which will be described later. The first operator 1 is, for example, an index finger of the user. The first operator 1 does not need to be an index finger of the user. The first operator 1 may be any finger of the user that can be directed toward an object. For example, as illustrated in FIG. 1, the user extends their index finger, serving as the first operator 1, with the other fingers folded. The user points the first operator 1, which is their index finger, in the hovering state at an object that the user intends to operate.

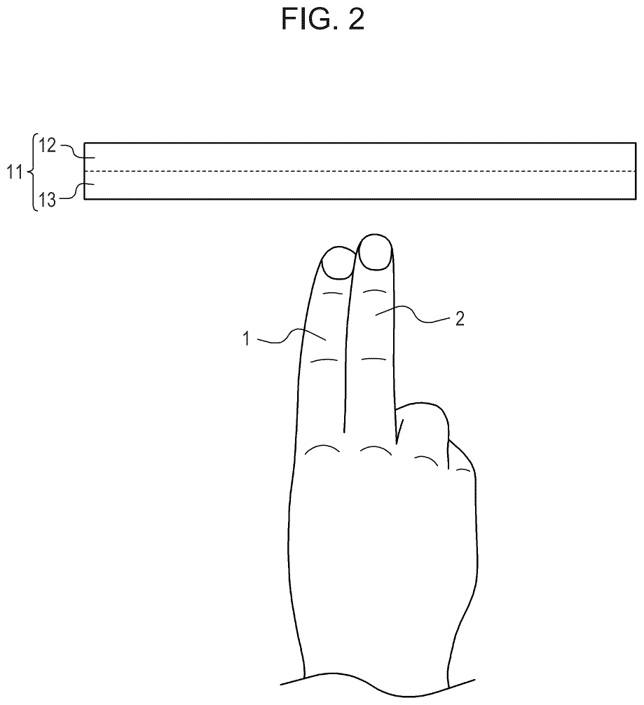

When the user directs the first operator 1 in the hovering state toward an object, the object becomes selected. To determine a designation for the selected object, as illustrated in FIG. 2, the user adds a second operator 2 in the hovering state to the first operator 1 remaining stationary. The second operator 2 is a finger next to the first operator 1. In cases where the first operator 1 is an index finger of the user, the second operator 2 is, for example, a middle finger of the user. When the second operator 2 is added to the first operator 1, the user designation for the selected object is determined.

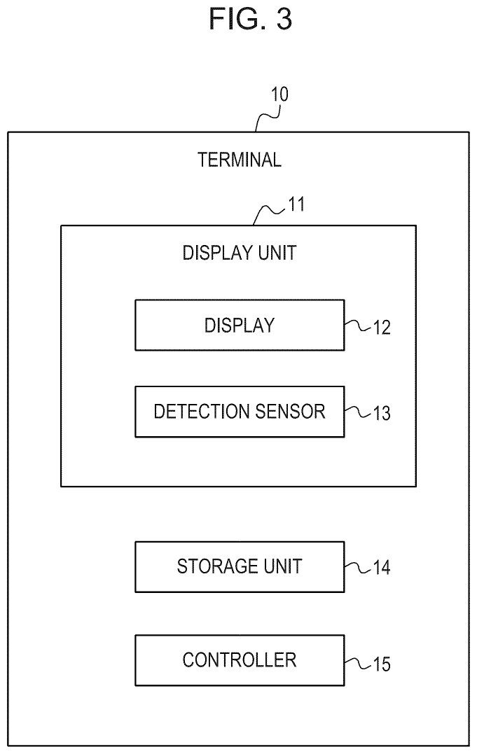

As illustrated in FIG. 3, the terminal 10 includes, in addition to the display unit 11, a storage unit 14, and a controller 15. The display unit 11 includes a display 12 and a detection sensor 13.

The display 12 is, for example, an LCD (liquid crystal display) or an organic EL (electroluminescence) display.

The detection sensor 13 is capable of detecting a capacitance. The detection sensor 13 is, for example, a capacitive touch sensor. The detection sensor 13 may be of a self-capacitance type or may be of a mutual capacitance type. The detection sensor 13 includes a transparent film and a transparent electrode made of, for example, ITO (indium tin oxide).

The transparent electrode may have a mesh pattern. Alternatively, strip-shaped transparent electrodes may be arranged in a lattice pattern.

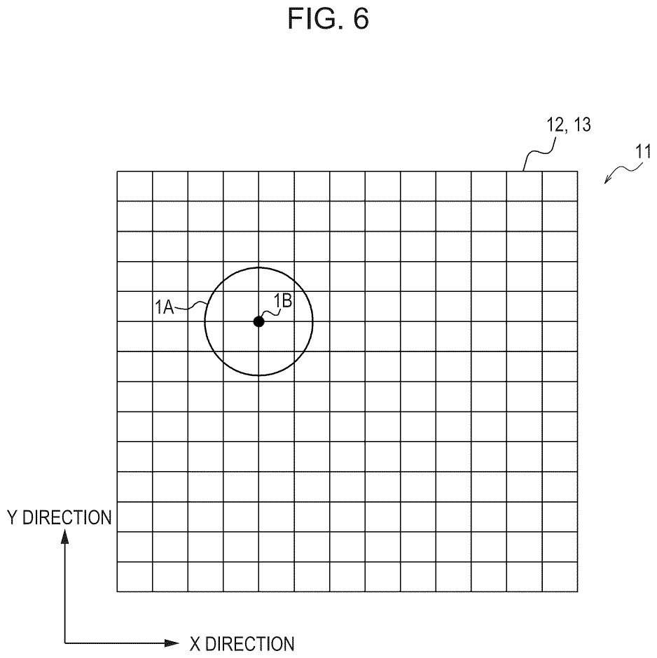

The detection sensor 13 is disposed on the display 12. Since the detection sensor 13 is disposed on the display 12, the detection sensor 13 can detect a capacitance above the display 12 in an XY coordinate system as illustrated in FIG. 6, which will be described later. The XY coordinate system is a two-dimensional coordinate system set on the display 12. The X direction corresponds to a direction from the left to the right when viewed from the front of the display 12. The Y direction corresponds to a direction from the bottom to the top when viewed from the front of the display 12. The X direction and the Y direction may be set to any directions with respect to the display 12. In the embodiment, each lattice point illustrated in FIG. 6 corresponds to X and Y coordinates at which the detection sensor 13 can detect a capacitance. The lattice point is also referred to as a “node”.

The storage unit 14 includes at least one semiconductor memory, at least one magnetic memory, at least one optical memory, or a combination of at least two types of them. The semiconductor memory is, for example, a RAM (random access memory) or a ROM (read-only memory). The RAM is, for example, an SRAM (static random access memory) or a DRAM (dynamic random access memory). The ROM is, for example, an EEPROM (electrically erasable programmable read-only memory). The storage unit 14 may serve as a main memory, an auxiliary memory, or a cache memory. The storage unit 14 stores data used for operation of the terminal 10 and data obtained through operation of the terminal 10.

The controller 15 includes at least one processor, at least one dedicated circuit, or a combination of them. The processor is, for example, a general-purpose processor, such as a CPU (central processing unit) or a GPU (graphics processing unit), or a special-purpose processor dedicated for specific processing. The dedicated circuit is, for example, an FPGA (field-programmable gate array) or an ASIC (application specific integrated circuit). The controller 15 executes processes related to operation of the terminal 10 while controlling the components of the terminal 10.

### <Determination Process>

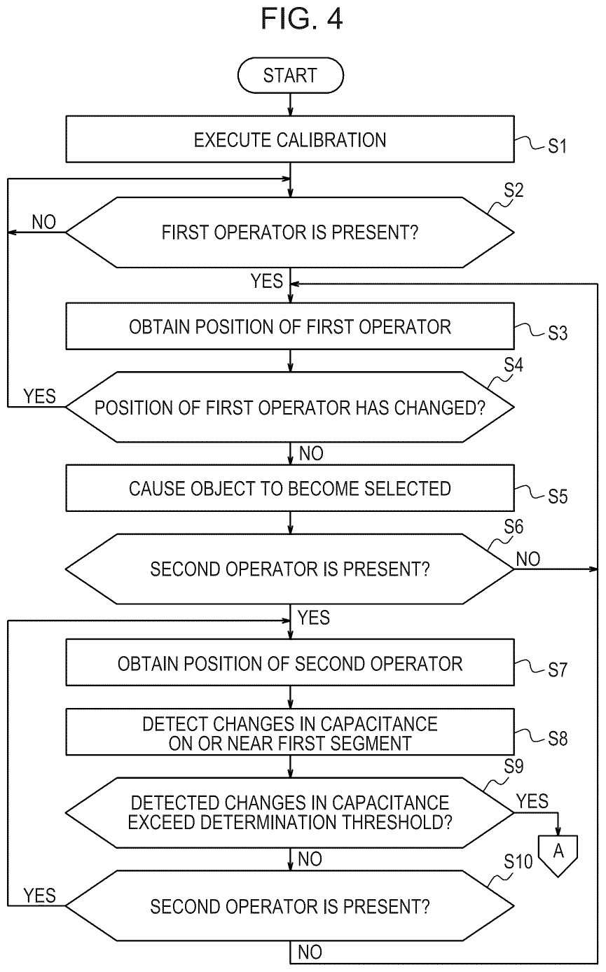

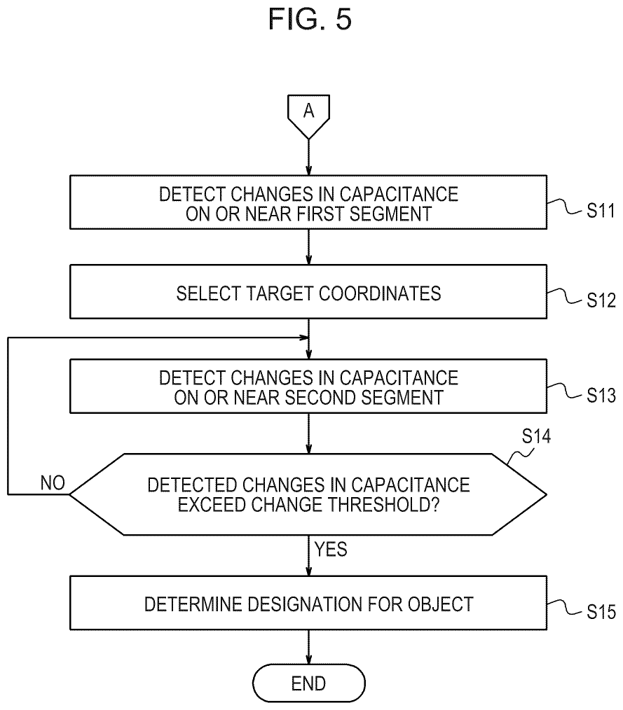

The controller 15 determines, based on information on the first operator 1 hovering relative to the display 12 and information on the second operator 2 hovering relative to the display 12, a user designation for an object displayed on the display 12. An example of the determination process will be described below with reference to FIGS. 4 and 5.

FIGS. 4 and 5 illustrate a flowchart illustrating an example determination process in accordance with an embodiment of the present disclosure.

For example, upon installation of the terminal 10, the controller 15 executes calibration (step S1). Calibration is a process in which the detection sensor 13 detects reference capacitances at discrete X and Y coordinates on the display 12. A reference capacitance at X and Y coordinates is a capacitance at the X and Y coordinates that is obtained when the terminal 10 is not in use by a user, that is, when a user's hand or the like is not close to the display 12. Capacitances at discrete X and Y coordinates on the display 12 vary depending on the environment around the terminal 10. For this reason, the controller 15 executes calibration to detect reference capacitances at discrete X and Y coordinates on the display 12. The controller 15 may store the detected reference capacitances at discrete X and Y coordinates on the display 12 in the storage unit 14.

Upon calibration, the controller 15 enables the detection sensor 13 to detect changes in capacitance at discrete X and Y coordinates on the display 12. A change in capacitance at X and Y coordinates is a change from the reference capacitance at the X and Y coordinates.

The controller 15 detects changes in capacitance at discrete X and Y coordinates on the display 12 through the detection sensor 13 to determine whether the first operator 1 is present (step S2). As an example of such an operation, the controller 15 may determine the presence of the first operator 1 in response to changes in capacitance at a series of X and Y coordinates exceeding a capacitance threshold. The capacitance threshold may be set based on the distance between the display unit 11 and a hovering operator that the terminal 10 can detect as a target object. For example, in FIG. 6, changes in capacitance at X and Y coordinates corresponding to respective lattice points in a circle 1A exceed the capacitance threshold. In FIG. 6, the controller 15 determines the presence of the first operator 1.

In response to determining the presence of the first operator 1 (YES in step S2), the controller 15 proceeds to step S3. In response to not determining the presence of the first operator 1 (NO in step S2), the controller 15 executes step S2 again.

In step S3, the controller 15 obtains the position of the first operator 1 relative to the display 12. As an example of such an operation, the controller 15 may obtain, as the position of the first operator 1 relative to the display 12, X and Y coordinates with the largest change in capacitance among changes in capacitance at multiple X and Y coordinates corresponding to the first operator 1. For example, referring to FIG. 6, a change in capacitance at coordinates 1B is the largest among changes in capacitance at X and Y coordinates corresponding to the respective lattice points in the circle 1A. In FIG. 6, the controller 15 obtains the coordinates 1B as the position of the first operator 1 relative to the display 12. The controller 15 may store the obtained position of the first operator 1 and the changes in capacitance at the multiple X and Y coordinates corresponding to the first operator 1 in the storage unit 14.

The controller 15 determines whether the position of the first operator 1 relative to the display 12 has changed within a predetermined amount of time after determination of the presence of the first operator 1 in step S2 (step S4). The controller 15 may determine whether the position of the first operator 1 has changed within the predetermined amount of time by detecting changes in capacitance at discrete X and Y coordinates on the display 12 through the detection sensor 13. The predetermined amount of time may be set based on, for example, specifications of the terminal 10 or a usage pattern of the user.

In response to determining that the position of the first operator 1 relative to the display 12 has changed within the predetermined amount of time after determination of the presence of the first operator 1 (YES in step S4), the controller 15 returns to step S2. In response to determining that the position of the first operator 1 relative to the display 12 remains unchanged for the predetermined amount of time after determination of the presence of the first operator 1 (NO in step S4), the controller 15 proceeds to step S5.

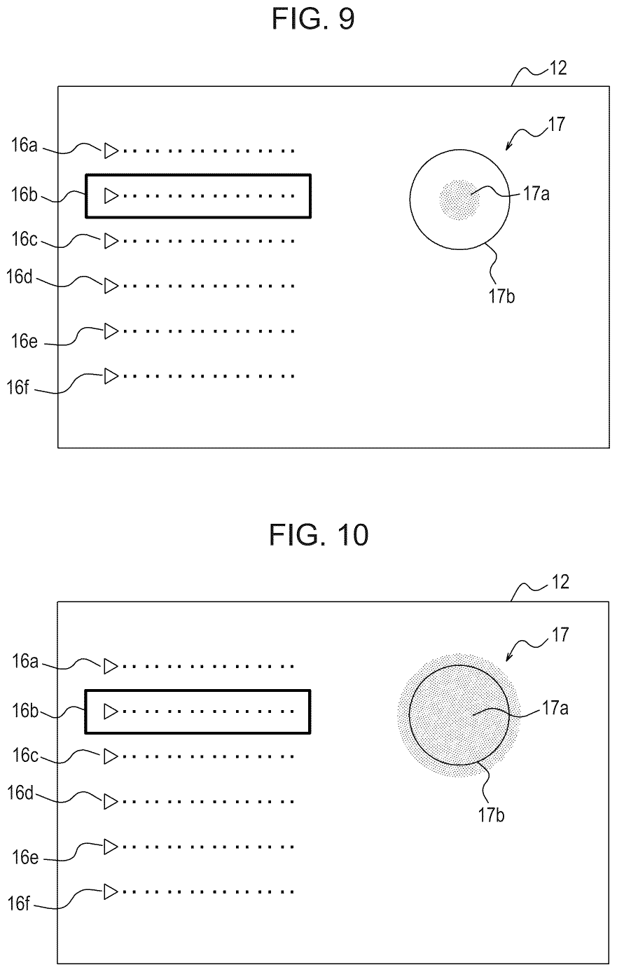

In step S5, the controller 15 causes an object toward which the first operator 1 in the hovering state is directed to become selected. The controller 15 may determine, based on the position of the first operator 1 relative to the display 12, an object to be selected. For example, in FIG. 6, the controller 15 determines, based on the coordinates 1B, an object to be selected. As will be described later with reference to FIG. 9, the controller 15 may cause a selected object to be displayed in a manner different form the other objects on the display 12.

In step S5, if there is no object at a place toward which the first operator 1 in the hovering state is directed, the controller 15 may return to step S2.

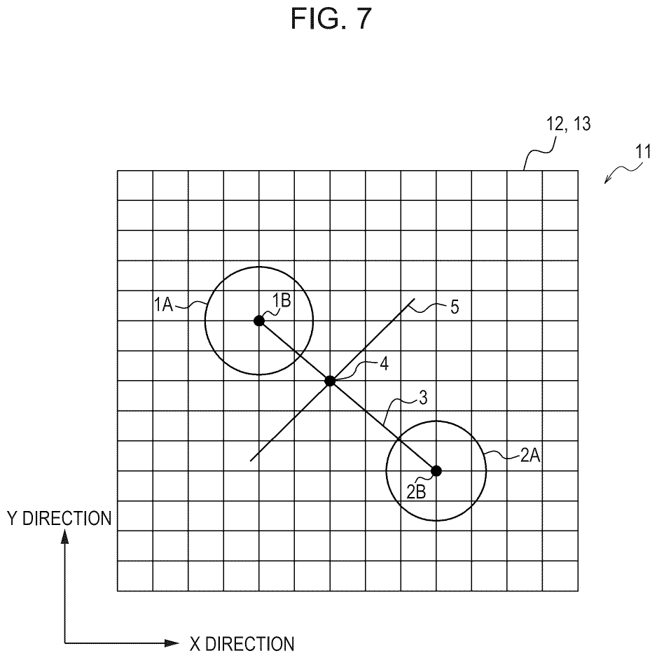

In step S6, the controller 15 detects changes in capacitance at discrete X and Y coordinates on the display 12 through the detection sensor 13 to determine whether the second operator 2 is present. The controller 15 may determine whether the second operator 2 is present within a predetermined distance from the first operator 1. The predetermined distance may be set based on an average distance between adjacent fingers of an open hand. The controller 15 may determine the presence of the second operator 2 in response to changes in capacitance at a series of X and Y coordinates exceeding the capacitance threshold in a manner same as or similar to that for the first operator 1. For example, in FIG. 7, changes in capacitance at X and Y coordinates corresponding to respective lattice points in a circle 2A exceed the capacitance threshold. The lattice points in the circle 2A are located within the predetermined distance from the coordinates 1B. The controller 15 determines that the second operator 2 is present within the predetermined distance from the first operator 1.

In response to determining the presence of the second operator 2 (YES in step S6), the controller 15 proceeds to step S7. In this case, the controller 15 may display an indicator, which will be described later with reference to FIG. 9, on the display 12 in response to determining the presence of the second operator 2 (YES in step S6). In response to determining that the second operator 2 is not present (NO in step S6), the controller 15 returns to step S3.

In step S7, the controller 15 obtains the position of the second operator 2 relative to the display 12. The controller 15 may obtain, as the position of the second operator 2 relative to the display 12, X and Y coordinates with the largest change in capacitance among changes in capacitance at multiple X and Y coordinates corresponding to the second operator 2 in a manner same as or similar to that for the first operator 1. For example, referring to FIG. 7, a change in capacitance at coordinates 2B is the largest among changes in capacitance at the X and Y coordinates corresponding to the respective lattice points in the circle 2A. In FIG. 7, the controller 15 obtains the coordinates 2B as the position of the second operator 2 relative to the display 12. The controller 15 may store the obtained position of the second operator 2 and the changes in capacitance at the multiple X and Y coordinates corresponding to the second operator 2 in the storage unit 14.

In step S8, the controller 15 sets a first segment. The first segment is a segment connecting the position of the first operator 1 and the position of the second operator 2 on the display 12. In other words, the first segment is included in a straight line passing through the position of the first operator 1 and the position of the second operator 2 on the display 12 and corresponds to a portion of the straight line that is located between the position of the first operator 1 and the position of the second operator 2. For example, referring to FIG. 7, the controller 15 sets a first segment 3. Upon setting the first segment, the controller 15 causes the detection sensor 13 to detect changes in capacitance at X and Y coordinates on or near the first segment. X and Y coordinates near the first segment may be, for example, X and Y coordinates at which the detection sensor 13 can detect a capacitance and that are closest to the first segment. For example, in FIG. 7, the controller 15 detects changes in capacitance at X and Y coordinates on or near the first segment 3.

In step S9, the controller 15 determines whether the changes in capacitance at the X and Y coordinates on or near the first segment detected in step S8 exceed a determination threshold. The determination threshold may be set based on changes in capacitance between two adjacent fingers of the user directed toward the display 12. The controller 15 may determine whether all of the changes in capacitance at the X and Y coordinates on or near the first segment exceed the determination threshold. Alternatively, the controller 15 may determine whether the smallest value of the changes in capacitance at the X and Y coordinates on or near the first segment or a representative value thereof exceeds the determination threshold. The representative value is, for example, an average value, a mode value, or a median value.

In response to determining that the changes in capacitance at the X and Y coordinates on or near the first segment exceed the determination threshold (YES in step S9), the controller 15 proceeds to step S11 illustrated in FIG. 5. When the changes in capacitance at the X and Y coordinates on or near the first segment exceed the determination threshold, the second operator 2 is likely to be close to the first operator 1.

In response to determining that the changes in capacitance at the X and Y coordinates on or near the first segment are equal to or less than the determination threshold (NO in step S9), the controller 15 proceeds to step S10. When the changes in capacitance at the X and Y coordinates on or near the first segment exceed the determination threshold, the second operator 2 is unlikely to be close to the first operator 1.

In step S10, the controller 15 causes the detection sensor 13 to detect changes in capacitance at discrete X and Y coordinates on the display 12 to determine whether the second operator 2 is present. The controller 15 may execute step S10 in a manner same as or similar to that in step S6. In response to determining the presence of the second operator 2 (YES in step S10), the controller 15 returns to step S7. In response to determining the absence of the second operator 2 (NO in step S10), the controller 15 returns to step S3.

In step S11 illustrated in FIG. 5, the controller 15 causes the detection sensor 13 to detect changes in capacitance at the X and Y coordinates on or near the first segment in a manner same as or similar to that in step S8.

In step S12, the controller 15 selects, based on the changes in capacitance detected in step S11, target coordinates from the coordinates on or near the first segment. The target coordinates are used to set a second segment, which will be described later. The controller 15 may select, as target coordinates, any coordinates from the X and Y coordinates on or near the first segment. By way of example, the controller 15 may select, as target coordinates, coordinates with the smallest change in capacitance among the changes in capacitance at the X and Y coordinates on or near the first segment. For example, in FIG. 7, the controller 15 selects, as target coordinates, coordinates 4 on the first segment 3.

In step S13, the controller 15 sets the second segment. The second segment is a segment that passes through the target coordinates and that is orthogonal to the first segment. For example, referring to FIG. 7, the controller 15 sets a second segment 5. A length from the target coordinates to one end of the second segment and a length from the target coordinates to the other end of the second segment may be set based on, for example, the thickness of a finger of the user. The controller 15 causes the detection sensor 13 to detect changes in capacitance at X and Y coordinates on or near the second segment. For example, in FIG. 7, the controller 15 causes the detection sensor 13 to detect changes in capacitance at X and Y coordinates on or near the second segment 5.

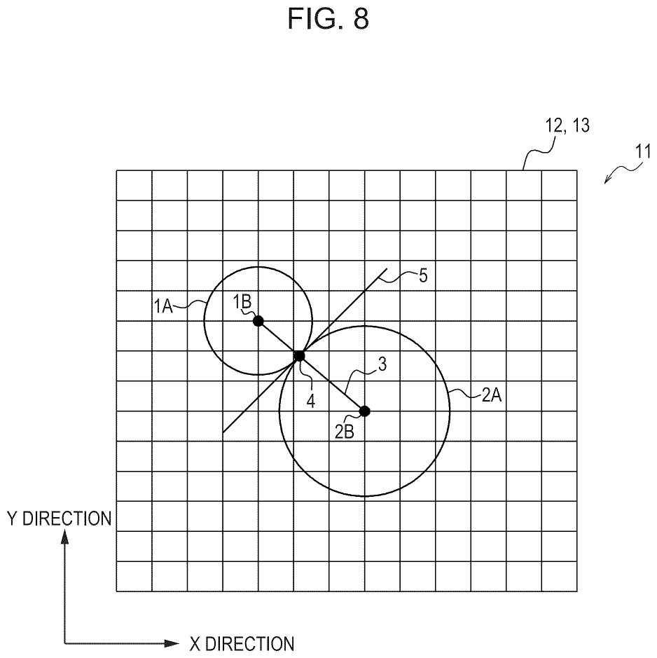

In step S14, the controller 15 determines whether the changes in capacitance at the X and Y coordinates on or near the second segment detected in step S13 exceed a change threshold. The change threshold may be set based on changes in capacitance between two adjacent fingers of the user aligned and directed toward the display 12. The controller 15 may determine whether all of the changes in capacitance at the X and Y coordinates on or near the second segment exceed the change threshold. Alternatively, the controller 15 may determine whether the smallest value of the changes in capacitance at the X and Y coordinates on or near the second segment or a representative value thereof exceeds the change threshold. The representative value is, for example, an average value, a mode value, or a median value. For example, in FIG. 8, the controller 15 determines that the changes in capacitance at the X and Y coordinates on or near the second segment 5 exceed the change threshold.

In response to determining that the changes in capacitance at the X and Y coordinates on or near the second segment exceed the change threshold (YES in step S14), the controller 15 proceeds to step S15. In response to determining that the changes in capacitance at the X and Y coordinates on or near the second segment are equal to or less than the change threshold (NO in step S14), the controller 15 returns to step S13.

In step S15, the controller 15 determines a user designation for the selected object. The controller 15 may generate a control signal to execute a process corresponding to the object associated with the determined designation. The controller 15 may transmit the generated control signal to another component of the terminal 10.

In response to determining in steps S14 and S15 that the distance between the first operator 1 and the second operator 2 is less than a distance threshold, the controller 15 can determine a user designation for an object displayed on the display 12. The change threshold can also be referred to as a distance threshold.

In this case, in response to determining that the second operator 2 is present within the predetermined distance from the first operator 1 (YES in step S6), the controller 15 may cause the detection sensor 13 to detect changes in capacitance above the display 12 before and after determining the presence of the second operator 2. Before and after determining the presence of the second operator 2, the controller 15 may calculate the area of a portion of the display 12 that has changes in capacitance exceeding the capacitance threshold. The controller 15 may calculate the difference between the area of a portion of the display 12 having changes in capacitance exceeding the capacitance threshold calculated before determination of the presence of the second operator 2 and the area of a portion of the display 12 having changes in capacitance exceeding the capacitance threshold calculated after determination of the presence of the second operator 2. If the calculated difference exceeds a predetermined value, the controller 15 may proceed to step S7. The predetermined value may be set based on the area of a portion of the display 12 that has changes in capacitance caused by a single finger and exceeding the capacitance threshold. Example operations using two operators include a pinch-in operation. The pinch-in operation includes moving two operators close to each other to reduce the distance between the two operators. In the pinch-in operation, therefore, the area of a portion of the display 12 that has changes in capacitance exceeding the capacitance threshold remains unchanged before and after determination of the presence of one operator within the predetermined distance from the other operator. Proceeding to step S7 in response to the above-described calculated difference exceeding the predetermined value allows an operation for determining a designation for an object to be more clearly distinguished from the pinch-in operation.

During execution of steps S1 to S15, the controller 15 may detect a user's hand or the like touching the display unit 11 through the detection sensor 13. In this case, the controller 15 may cause the display 12 to display an alert notification. By way of example, the controller 15 may cause the display 12 to display text information, such as “Please do not touch the display”. In response to the alert notification displayed on the display 12, the user can move their hand or the like away from the display unit 11. Such a configuration can avoid a situation in which the first and second operators 1 and 2 in the hovering state may fail to be detected.

### <Display Process>

The controller 15 may cause an object selected from multiple objects displayed on the display 12 to be displayed in a manner different from the other objects. As described above, in step S5, the controller 15 causes an object toward which the first operator 1 in the hovering state is directed to become selected. In step S5, the controller 15 may cause the selected object to be displayed in a manner different from the other objects.

For example, the display 12 illustrated in FIG. 9 displays objects 16a, 16b, 16c, 16d, 16e, and 16f. The objects 16a to 16f are menus. Referring to FIG. 9, the first operator 1 in the hovering state is directed toward the object 16b. The controller 15 causes the object 16b to become selected in step S5. The controller 15 causes the selected object 16b to be displayed in a manner different from the other objects, such as the object 16a. In FIG. 9, the controller 15 causes the object 16b to be displayed in a box on the display 12. Such a configuration enables the user to readily grasp the selected object 16b.

In response to determining the presence of the second operator 2 within the predetermined distance from the first operator 1 as described above (YES in step S6), the controller 15 may display an indicator on the display 12. This indicator indicates the distance between the first operator 1 and the second operator 2. The indicator may indicate the distance between the first operator and the second operator in association with the distance threshold. The controller 15 may calculate the distance between the first operator 1 and the second operator 2 based on the position of the first operator 1 relative to the display 12 and the position of the second operator 2 relative to the display 12. The controller 15 may cause the indicator to be displayed in the vicinity of the selected object or to be superimposed on the selected object.

For example, the display 12 illustrated in FIG. 9 displays an indicator 17. The indicator 17 is displayed in the vicinity of the selected object 16b. The indicator 17 includes a circle 17a and a circle 17b. The circle 17a has a radius corresponding to the distance between the first operator 1 and the second operator 2. As the distance between the first operator 1 and the second operator 2 decreases, the radius of the circle 17a increases. The circle 17b has a radius corresponding to the distance threshold. The center of the circle 17a coincides with the center of the circle 17b. In other words, the circles 17a and 17b are concentric circles. When the radius of the circle 17a is larger than that of the circle 17b, a user designation for the selected object 16b is determined. FIG. 10 illustrates the indicator 17 displayed upon determination of a user designation for the object 16b. Referring to FIG. 10, the radius of the circle 17a is larger than that of the circle 17b. The indicator 17 displayed in such a manner enables the user to easily grasp to what extent the distance between the first operator 1 and the second operator 2 can be reduced to determine a user designation for the selected object 16b.

In the embodiment, as described above, the controller 15 of the terminal 10 determines a user designation for an object displayed on the display 12 based on information on the first operator 1 hovering relative to the display and information on the second operator 2 hovering relative to the display.

As a comparative example, it is assumed that a user designation for a selected object is determined by moving the first operator 1 close to or away from the selected object. A user's hand tends to move in the air. It is therefore difficult to maintain a constant distance between the first operator 1 and the display unit 11. In other words, unintended motion of a user's hand may move the first operator 1 close to or away from the selected object. In this case, in the comparative example, a designation for the selected object may be determined by unintended motion of a user's hand.

In contrast to the comparative example, in the embodiment, the controller 15 determines a user designation for an object displayed on the display 12 based on information on the first operator 1 and information on the second operator 2. In other words, in the embodiment, a designation for an object is determined by using information on the first operator 1 and the second operator 2, instead of using only information on the first operator 1. In the embodiment, using information on the first operator 1 and information on the second operator 2 in the above-described manner can avoid a situation in which a designation for an object may be determined by unintended motion of a user's hand as in the comparative example.

Therefore, the embodiment achieves an improved accuracy of detecting a non-contact operation.

Furthermore, in the embodiment, the controller 15 may determine a user designation for an object displayed on the display 12 in response to determining that the distance between the first operator 1 and the second operator 2 is less than the distance threshold. Example operations using two operators include a pinch-out operation. The pinch-out operation includes moving two operators away from each other to increase the distance between the two operators. In response to determination that the distance between the first operator 1 and the second operator 2 is less than the distance threshold, a designation for an object is determined. This allows an operation for determining a designation for an object to be more clearly distinguished from the pinch-out operation. Thus, a designation for an object can be determined accurately.

In the embodiment, in response to the first operator 1 remaining at a position relative to the display 12 for a predetermined amount of time after determination of the presence of the first operator 1, the controller 15 may determine the presence or absence of the second operator 2. As described above, example operations using two operators include a pinch-in operation. Since the two operators are moved close to each other in the pinch-in operation, the respective positions of the two operators change. Determining the presence or absence of the second operator 2 in response to the first operator 1 remaining at a position for the predetermined amount of time allows an operation for determining a designation for an object to be more clearly distinguished from a pinch-in operation.

In the embodiment, if the first operator 1 remains at a position relative to the display 12 for the predetermined amount of time, the controller 15 may cause an object toward which the first operator is directed to be selected from multiple objects displayed on the display 12. The controller 15 may cause the selected object to be displayed in a manner different from the other objects. Such a configuration enables the user to easily grasp the selected object, as described above with reference to FIG. 9.

In the embodiment, in response to determining the presence of the second operator 2, the controller 15 may cause the display 12 to display an indicator indicating the distance between the first operator 1 and the second operator 2. The indicator may indicate the distance between the first operator 1 and the second operator 2 in association with the distance threshold. Such a configuration enables the user to easily grasp to what extent the distance between the first operator 1 and the second operator 2 can be reduced to determine a designation for the selected object, as described above with reference to FIGS. 9 and 10.

### Another Embodiment

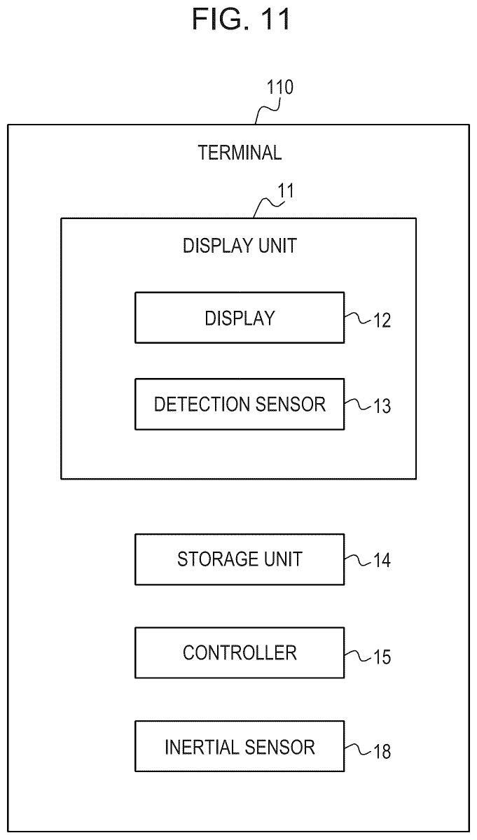

In another embodiment, as illustrated in FIG. 11, a terminal 110 includes the display unit 11, the storage unit 14, the controller 15, and an inertial sensor 18.

The inertial sensor 18 is capable of detecting the tilt angle of the display 12. The inertial sensor 18 may include an acceleration sensor or an angular velocity sensor or may include an IMU (inertial measurement unit).

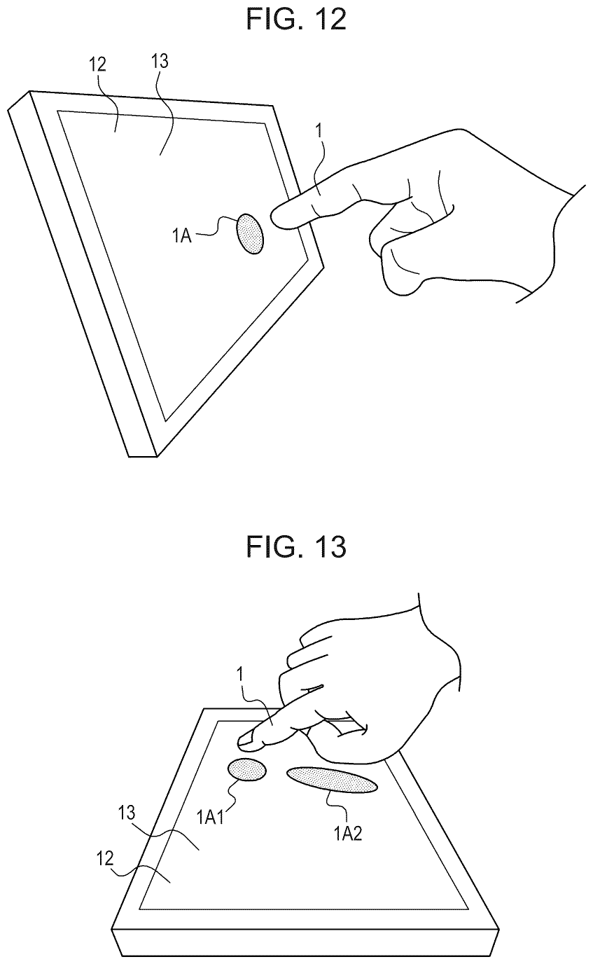

A portion of the display 12 above which capacitances associated with a user's finger are detected may vary depending on the angle at which the display 12 is installed, even if the finger is in the same pose. Such a case will be described with reference to FIGS. 12 and 13.

FIG. 12 illustrates the display 12 oriented substantially parallel to the vertical direction. For the display 12 oriented substantially parallel to the vertical direction, when a user directs the first operator 1 toward the display 12, the distance between the display 12 and the tip of the first operator 1 is shorter than that between the display 12 and each of the other fingers. Thus, the controller 15 can detect capacitances associated only with the first operator 1 through the detection sensor 13. The circle 1A illustrated in FIG. 12 corresponds to the circle 1A illustrated in FIG. 6.

FIG. 13 illustrates the display 12 oriented substantially parallel to the horizontal direction. The pose of the fingers of the user illustrated in FIG. 13 is the same as that illustrated in FIG. 12. For the display 12 oriented substantially parallel to the horizontal direction, when the user directs the first operator 1 toward the display 12, the distance between the display 12 and the tip of the first operator 1 is substantially equal to the distance between the display 12 and each of the other fingers. Thus, the controller 15 detects capacitances associated with the first operator 1 and capacitances associated with the other fingers. For example, the controller 15 detects capacitances above a portion indicated by a circle 1A1 and capacitances above a portion indicated by a circle 1A2. In such a case where the detection sensor 13 detects capacitances above two portions of the display 12, it is difficult to detect the second operator 2 through the detection sensor 13.

In another embodiment, the controller 15 causes the inertial sensor 18 to detect the tilt angle of the display 12 relative to the horizontal direction. If the tilt angle of the display 12 relative to the horizontal direction is equal to or less than a predetermined angle, the controller 15 does not accept a non-contact operation. The predetermined angle may be set based on, for example, the usage pattern of the user or the accuracy with which the detection sensor 13 detects a capacitance. The predetermined angle is, for example, 30 degrees. Such a configuration can further reduce false detection of a non-contact operation.

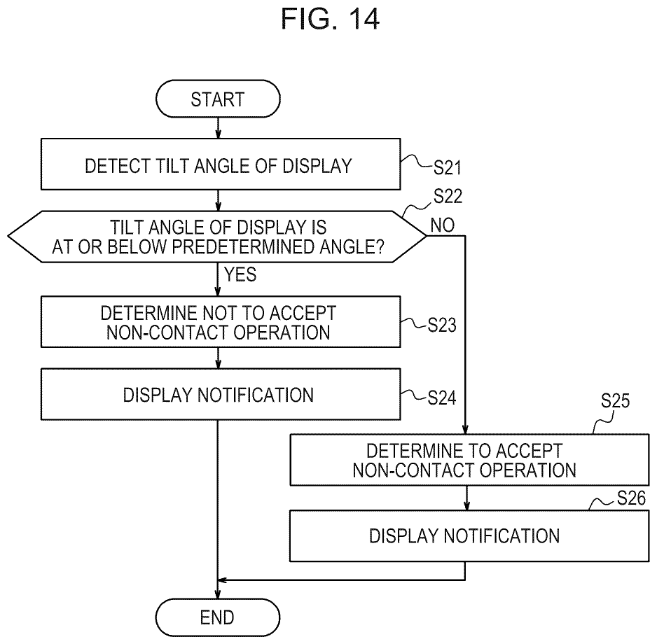

FIG. 14 is a flowchart illustrating an example notification process in accordance with another embodiment of the present disclosure. The controller 15 starts an operation in step S21 in response to, for example, turn-on of the terminal 10. For example, upon installation of the display 12, the terminal 10 may be turned on by the user.

The controller 15 causes the inertial sensor 18 to detect the tilt angle of the display 12 relative to the horizontal direction (step S21). The controller 15 determines whether the tilt angle of the display 12 relative to the horizontal direction is equal to or less than the predetermined angle (step S22).

In response to determining that the tilt angle of the display 12 relative to the horizontal direction is equal to or less than the predetermined angle (YES in step S22), the controller 15 determines not to accept a non-contact operation (step S23). The controller 15 causes the display 12 to display a notification indicating that the non-contact operation is not accepted (step S24). After step S24, the controller 15 may cause the operation mode of the terminal 110 to transition to another mode. Examples of another mode include a mode of accepting a touch input on the display unit 11 through the detection sensor 13.

In response to determining that the tilt angle of the display 12 relative to the horizontal direction is greater than the predetermined angle (NO in step S22), the controller 15 determines to accept the non-contact operation (step S25). The controller 15 causes the display 12 to display a notification indicating that the non-contact operation is accepted (step S26). After execution of step S26, the controller 15 may proceed to step S1 illustrated in FIG. 4.

In another embodiment, as described above, the controller 15 of the terminal 110 does not accept a non-contact operation if the tilt angle of the display 12 relative to the horizontal direction is equal to or less than the predetermined angle. Such a configuration can further reduce false detection of a non-contact operation. The controller 15 causes the display 12 to display a notification indicating that the non-contact operation is not accepted.

Displaying such a notification allows the user to know that the terminal 110 does not accept the non-contact operation. Furthermore, the user can adjust the tilt angle of the display 12 so that the terminal 110 accepts the non-contact operation.

In another embodiment, the rest of the configuration and other advantages of the terminal 110 are the same as or similar to those of the terminal 10.

While the present disclosure has been described with reference to the drawings and examples, it should be noted that those skilled in the art can easily make various variations or modifications based on the present disclosure. Therefore, it should be noted that these variations or modifications fall within the scope of the present disclosure. For example, the functions included in each functional part can be rearranged in a logically consistent manner. For example, a plurality of functional parts may be combined into one or may be divided. The above-described embodiments according to the present disclosure are not limited to being implemented strictly in accordance with the respective embodiments described above, and may be implemented by combining the features or omitting some of the features as appropriate. In other words, those skilled in the art can make various variations and modifications to the content of the present disclosure based on the present disclosure.

Therefore, these variations and modifications fall within the scope of the present disclosure. For example, each functional part, each means, each step, or the like in each of the embodiments can be added to another embodiment without logical inconsistency or can replace each functional part, each means, each step, or the like in another embodiment. In each of the embodiments, a plurality of functional parts, means, steps, or the like can be combined into one or can be divided. The above-described embodiments of the present disclosure are not limited to being implemented strictly in accordance with the respective embodiments described above, and can also be implemented by combining the features or omitting some of the features as appropriate.

For example, assuming that a pinch-in operation is not used for the above-described terminals 10 and 110, an operation for determining a designation for an object may be an operation including directing the first operator 1 and the second operator 2 forming a peace sign toward an object and bringing the operators forming the peace sign into contact with each other. The peace sign is formed in such a manner that the spacing between the first operator 1 and the second operator 2 is increased to form a V-shape with the first operator 1 and the second operator 2. In this case, the controller 15 does not need to execute step S4 illustrated in FIG. 4. In other words, after step S3, the controller 15 may proceed to step S5.

For example, in an embodiment, a general-purpose computer can function as the terminal 10 or 110 in accordance with the above-described embodiment. Specifically, a program describing the content of processing to implement the functions of the terminal 10 or 110 in accordance with the above-described embodiment is stored in a memory of the general-purpose computer. The program is read and executed by a processor. Therefore, the present disclosure can also be implemented as a processor-executable program or a non-transitory computer-readable medium storing the program.

In an embodiment, (1) a terminal includes:
a display; and
a controller configured to determine a user designation for an object displayed on the display based on information on a first operator and information on a second operator, the first operator and the second operator hovering relative to the display.

(2) in the Terminal According to (1),
the information on the first operator may be based on a capacitance associated with the first operator relative to the display, and the information on the second operator may be based on a capacitance associated with the second operator relative to the display.

(3) In the terminal according to (1) or (2),
the controller may be configured to determine a user designation for an object displayed on the display in response to determining, based on the information on the first operator and the information on the second operator, that the distance between the first operator and the second operator is less than a distance threshold.

(4) In the terminal according to any one of (1) to (3),
a first segment may be a segment connecting the position of the first operator and the position of the second operator on the display,
a second segment may be a segment passing through a point on the first segment and being orthogonal to the first segment on the display, and
the controller may be configured to, in response to determining that a change in capacitance on or near the second segment on the display exceeds a change threshold, determine that the distance between the first operator and the second operator is less than the distance threshold.

(5) In the terminal according to (4),
the controller may be configured to, in response to determining that a change in capacitance on or near the first segment on the display exceeds a determination threshold, determine whether a change in capacitance on or near the second segment on the display exceeds the change threshold.

(6) In the terminal according to any one of (1) to (5),
the controller may be configured to, in response to the first operator remaining at a position relative to the display for a predetermined amount of time after determination of the presence of the first operator, determine the presence or absence of the second operator.

(7) In the terminal according to any one of (3) to (6),
the controller may be configured to, in response to determining the presence of the second operator, determine whether the distance between the first operator and the second operator is less than the distance threshold.

(8) In the terminal according to any one of (1) to (7),
the controller may be configured to, in response to determining the presence of the second operator, cause the display to display an indicator indicating the distance between the first operator and the second operator.

(9) In the terminal according to (8),
the indicator may indicate the distance between the first operator and the second operator in association with the distance threshold.

(10) In the terminal according to any one of (1) to (9),
the controller may be configured to, in response to the first operator remaining at a position relative to the display for a predetermined amount of time after determination of the presence of the first operator, cause an object toward which the first operator is directed among multiple objects displayed on the display to be displayed in a manner different from the other objects.

(11) In the terminal according to any one of (1) to (10),
the controller may be configured to, when the tilt angle of the display relative to the horizontal direction is equal to or less than a predetermined angle, determine not to accept a non-contact operation and cause the display to display a notification indicating that the non-contact operation is not accepted.

(12) In the terminal according to any one of (1) to (11),
the controller may be configured to, when the tilt angle of the display relative to the horizontal direction is greater than a predetermined angle, determine to accept a non-contact operation and cause the display to display a notification indicating that the non-contact operation is accepted.

(13) In the terminal according to any one of (1) to (12),
the first operator and the second operator may be two adjacent fingers.

(14) In the terminal according to any one of (1) to (13),
the first operator may be an index finger, and
the second operator may be a middle finger.

In an embodiment, (15) an operation method includes:
determining a user designation for an object displayed on a display based on information on a first operator and information on a second operator, the first operator and the second operator hovering relative to the display.

In an embodiment, (16) a program causes a computer to execute an operation including:
determining a user designation for an object displayed on a display based on information on a first operator and information on a second operator, the first operator and the second operator hovering relative to the display.

In the present disclosure, the terms “first”, “second”, and the like are identifiers to distinguish between the components. In the present disclosure, the identifiers representing numbers for the components distinguished with the terms “first”, “second”, and the like are interchangeable. For example, the identifier “first” of the first operator is interchangeable with the identifier “second” of the second operator. The identifiers are interchanged simultaneously. After the identifiers are interchanged, the components are distinguished from each other. The identifiers may be removed. The components without the identifiers are distinguished from each other by using reference signs. In the present disclosure, the description of identifiers such as “first” and “second” should not be used as a basis for interpreting the order of the components or the existence of identifiers representing smaller numbers.

### REFERENCE SIGNS

1 first operator
2 second operator
1A, 1A1, 1A2, 2A circle
1B, 2B coordinates
3 first segment
4 coordinates
5 second segment
10, 110 terminal
11 display unit
12 display
13 detection sensor
14 storage unit
15 controller
16a, 16b object
17 indicator
17a, 17b circle
18 inertial sensor

1. A terminal comprising:
a display; and
a controller configured to determine a user designation for an object displayed on the display based on information on a first operator and information on a second operator, the first operator and the second operator hovering relative to the display.

2. The terminal according to claim 1, wherein the information on the first operator is based on a capacitance associated with the first operator relative to the display, and the information on the second operator is based on a capacitance associated with the second operator relative to the display.

3. The terminal according to claim 1, wherein the controller is configured to determine a user designation for an object displayed on the display in response to determining, based on the information on the first operator and the information on the second operator, that a distance between the first operator and the second operator is less than a distance threshold.

4. The terminal according to claim 3, wherein
a first segment is a segment connecting a position of the first operator and a position of the second operator on the display,
a second segment is a segment passing through a point on the first segment and being orthogonal to the first segment on the display, and
the controller is configured to, in response to determining that a change in capacitance on or near the second segment on the display exceeds a change threshold, determine that a distance between the first operator and the second operator is less than the distance threshold.

5. The terminal according to claim 4, wherein the controller is configured to, in response to determining that a change in capacitance on or near the first segment on the display exceeds a determination threshold, determine whether a change in capacitance on or near the second segment on the display exceeds the change threshold.

6. The terminal according to claim 3, wherein the controller is configured to, in response to the first operator remaining at a position relative to the display for a predetermined amount of time after determination of presence of the first operator, determine presence or absence of the second operator.

7. The terminal according to claim 6, wherein the controller is configured to, in response to determining presence of the second operator, determine whether a distance between the first operator and the second operator is less than the distance threshold.

8. The terminal according to claim 6, wherein the controller is configured to, in response to determining presence of the second operator, cause the display to display an indicator indicating a distance between the first operator and the second operator.

9. The terminal according to claim 8, wherein the indicator indicates the distance between the first operator and the second operator in association with the distance threshold.

10. The terminal according to claim 1, wherein the controller is configured to, in response to the first operator remaining at a position relative to the display for a predetermined amount of time after determination of presence of the first operator, cause an object toward which the first operator is directed among multiple objects displayed on the display to be displayed in a manner different from other objects.

11. The terminal according to claim 1, wherein the controller is configured to, when a tilt angle of the display relative to a horizontal direction is equal to or less than a predetermined angle, determine not to accept a non-contact operation and cause the display to display a notification indicating that the non-contact operation is not accepted.

12. The terminal according to claim 1, wherein the controller is configured to, when a tilt angle of the display relative to a horizontal direction is greater than a predetermined angle, determine to accept a non-contact operation and cause the display to display a notification indicating that the non-contact operation is accepted.

13. The terminal according to claim 1, wherein the first operator and the second operator are two adjacent fingers.

14. The terminal according to claim 13, wherein
the first operator is an index finger, and
the second operator is a middle finger.

15. An operation method comprising:
determining a user designation for an object displayed on a display based on information on a first operator and information on a second operator, the first operator and the second operator hovering relative to the display.

16. A program that causes a computer to execute an operation comprising:
determining a user designation for an object displayed on a display based on information on a first operator and information on a second operator, the first operator and the second operator hovering relative to the display.
